(19) United States
(12) Patent Application Publication
(10) Pub. No.: US 2005/0102456 A1
(43) Pub. Date: May 12, 2005

(54) Command transmission method and command transmission apparatus in pipeline bus system

(75) Inventor: Shin-wook Kang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/981,552

(22) Filed: Nov. 5, 2004

(30) Foreign Application Priority Data
Nov. 6, 2003 (KR) 2003-78328

(51) Int. Cl. G06F 13/00

(52) U.S. Cl. 710/113; 710/110

(57) ABSTRACT

A command transmission method and apparatus, capable of improving command transmission efficiency by using a queue, when the queue is required during an operation of a command bus in a pipeline bus system includes determining whether a command bus of the pipeline bus system is in a busy state; and transmitting a command from the master to a target slave while selectively using a queue protocol of an arbiter of the pipeline bus system according to a result of the determination.

### CROSS-REFERENCE TO RELATED APPLICATION

This application claims the benefit of Korean Patent Application No. 2003-78328, filed on Nov. 6, 2003 in the Korean Intellectual Property Office, the disclosure of which is incorporated herein in its entirety by reference.

### BACKGROUND OF THE INVENTION

1. Field of the Invention

The present invention relates to a pipeline bus system, and more particularly, a command transmission method and apparatus capable of reducing latency of command transmission.

2. Description of the Related Art

A conventional pipeline bus system transmits commands using a queue protocol. That is, in each core module of the pipeline bus system, such as an arbiter, a hub, or a slave, a command queue is generated and a command is transmitted using a corresponding queue protocol.

A command for a master connected to the pipeline bus system to access a slave also connected to the pipeline bus system is transmitted as illustrated in FIG. 1.

FIG. 1 is a timing diagram of each module in a pipeline bus system in which a queue is generated in each of an arbiter, a hub, and a slave when a command is transmitted from a master to the slave.

Referring to FIG. 1, when the master requests that a command bus have access to the arbiter as shown in FIG. 1A, the arbiter determines a priority using an arbitration algorithm. When the access of the command bus is granted to the master according to the priority, a signal granting the access of the command bus is transmitted from the arbiter to the master as shown in FIG. 1B. Accordingly, the master transmits a command to the arbiter as shown in FIG. 1C.

The arbiter stores the command transmitted from the master in a command queue. The arbiter requests command transmission to the hub as shown in FIG. 1D. If a command queue of the hub is not in a full state, the hub transmits a permission signal for the command transmission to the arbiter as shown in FIG. 1E. The arbiter then transmits the command stored in the command queue to the hub as shown in FIG. 1F.

The hub stores the command transmitted from the arbiter in the command queue and requests command transmission to the slave as shown in FIG. 1G. If a command queue of the slave is not in the full state, the slave transmits a permission signal for the command transmission to the hub as shown in FIG. 1H. The hub then transmits the command stored in the command queue to the slave as shown in FIG. 11.

As described above, a period of 7 clock pulses is required for command transmission in a conventional pipeline bus system. The 7 clock pulses for one command transmission are divided into 3 clock pulses from the master to the arbiter, 2 clock pulses from the arbiter to the hub, and 2 clock pulses from the hub to the slave.

The period of 7 clock pulses is required for the command transmission even when the command bus is not in a busy state. That is, even when the command bus is not in the busy state, the command is stored in the queues generated by the arbiter and the hub.

The queue protocol in the arbiter, the hub, and the slave operates as illustrated in FIG. 2. Referring to FIG. 2, the queues generated in the arbiter and the hub of the conventional pipeline bus system store and output the command using a first-in first-out (FIFO) method. Therefore, even when the command bus is not in a busy state, the command queues generated in the arbiter and the hub store the command.

If the master transmits a command requesting one data transmission, a command transmission to data transmission ratio becomes 7:1 not including an initial operation time of the slave. Therefore, since a command transmission has a greater importance than a data transmission in the master having a low data transmission rate, data transmission efficiency is relatively low.

Also, when a command is transmitted, if the command queue of the slave is not in a full state, since the command is output as soon as the command is stored in the command queues of the arbiter and the hub, it is possible that no command remains stored in the command queues of the arbiter and the hub. This situation can also occur when a plurality of masters attempt to access one slave.

In the above-described situations, it is useless for commands to be stored in the command queues of the arbiter and the hub. Furthermore, since latency is generated in command transmission due to command queue protocol operation of the arbiter and the hub, transmission efficiency of a command bus decreases.

### SUMMARY OF THE INVENTION

According to an aspect of the present invention, there is provided a command transmission method and apparatus capable of reducing latency in command transmission by removing a use of a redundant queue protocol during an operation of a command bus in a pipeline bus system.

According to an aspect of the present invention, there is also provided a command transmission method and apparatus capable of improving command transmission efficiency by using a queue protocol when the queue is required during operation of a command bus in a pipeline bus system.

According to an aspect of the present invention, there is provided a command transmission method and apparatus capable of reducing latency in a command transmission by removing a queue protocol operation in a hub during an operation of a command bus in a pipeline bus system.

According to an aspect of the present invention, there is provided a command transmission method in a pipeline bus system to which at least one master and at least one slave are connected, the method including: determining whether a command bus of the pipeline bus system is in a busy state; and transmitting a command from the master to a target slave while selectively using a queue protocol of an arbiter of the pipeline bus system according to a result of the determination.

According to another aspect of the present invention, there is provided a command transmission apparatus of a pipeline bus system to which at least one master is connected, the apparatus including: a target slave, which is connected to the pipeline bus system and transmits state information determining whether a command bus of the pipeline bus system is in a busy state; and an arbiter, which transmits a command from the at least one master to the target slave while a queue protocol is selectively used according to the state information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become more apparent and more readily appreciated from the following description of the embodiments, taken in conjunction with the accompanying drawings of which:

FIG. 1A through FIG. 1I are timing diagrams illustrating command transmissions in a conventional pipeline bus system;

FIG. 2 illustrates an operation of a queue protocol in a conventional pipeline bus system;

FIG. 3 is a block diagram of a pipeline bus system including a command transmission apparatus according to an embodiment of the present invention;

FIG. 4 is a block diagram of an arbiter illustrated in FIG. 3;

FIG. 5A through FIG. 5F are timing diagrams of the pipeline bus system illustrated in FIG. 3;

FIG. 6A illustrates an operation in a queue protocol according to an embodiment of the present invention when a command bus is not in a busy state;

FIG. 6B illustrates an operation in a queue protocol according to an embodiment of the present invention when the command bus is in the busy state;

FIG. 7A through FIG. 7Q are timing diagrams of modules of the pipeline bus system when a command is transmitted according to an embodiment of the present invention; and

FIG. 8 is a flowchart illustrating a command transmission method according to an embodiment of the present invention.

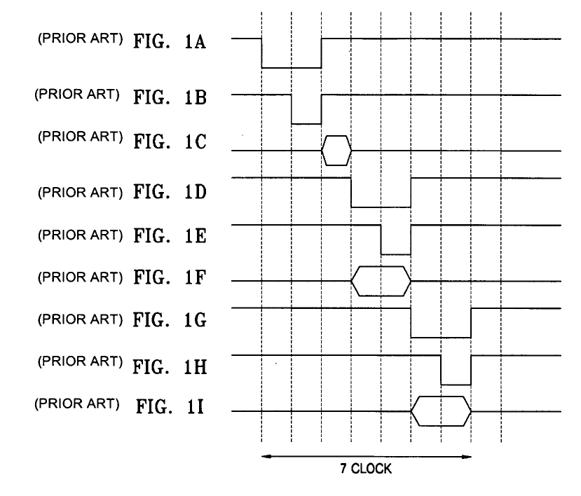

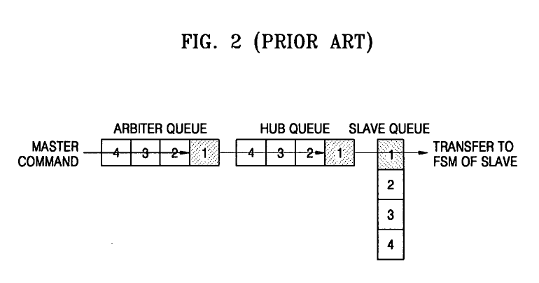

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

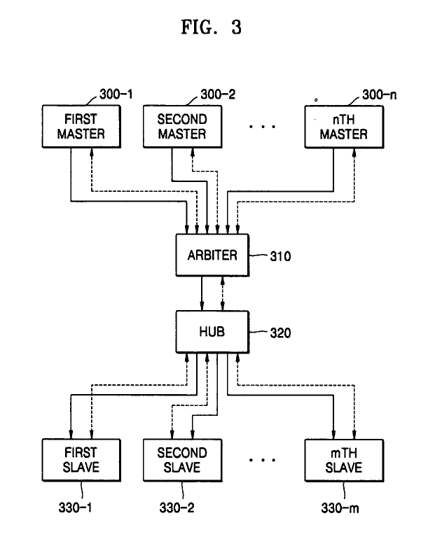

FIG. 3 is a block diagram of a pipeline bus system including a command transmission apparatus according to an embodiment of the present invention. Referring to FIG. 3, the pipeline bus system includes first through nth masters 300_1 through 300_{—}n, an arbiter 310, a hub 320, and first through mth slaves 330_1 through 330_{—}m. Dotted lines between modules are protocol operation lines for transmitting a command and solid lines are command transmission lines.

Each of the first through nth masters 300_1 through 300_{—}n can transmit a command to a target slave included in the first through mth slaves 330_1 through 330_{—}m by requesting a command transmission. The command can include, for example, an address, a burst, a size, and a low active read or write (nRW) command.

The arbiter 310 arbitrates a command bus for the first through nth masters 300_1 through 300_{—}n using a preset arbitration algorithm. That is, if a plurality of masters request a command transmission, the arbiter 310 determines a priority and grants access of the command bus. If a master requests a command transmission, the arbiter 310 immediately grants the master access to the command bus.

The arbiter 310 operates a queue protocol according to whether the command bus is in a busy state. That is, if the command bus is not in the busy state, the arbiter 310 sets the queue protocol to a bypass mode and operates the queue protocol, and if the command bus is in the busy state, the arbiter 310 sets the queue protocol to an active mode and operates the queue protocol. Whether the command bus is in the busy state is determined by information transmitted from the hub 320. If the command bus is not in the busy state, a state of the command bus is defined as an idle state.

When the queue protocol of the arbiter 310 is set to the bypass mode, the arbiter 310 bypasses the received command to the hub 320. However, when the queue protocol of the arbiter 310 is set to the active mode, the arbiter 310 stores the received command in a queue and then transmits the stored command to the hub 320. The active mode is defined as a mode of the arbiter 310 when not in the bypass mode.

Also, after setting the queue protocol to the active mode, if determined that the command bus is not in the busy state, the command stored in the queue of the arbiter 310 is transmitted to the hub 320.

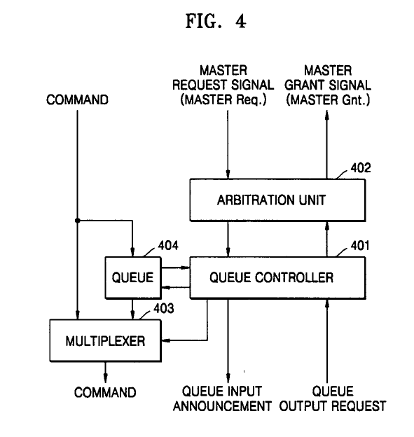

FIG. 4 is a block diagram of the arbiter 310. Referring to FIG. 4, the arbiter 310 includes a queue controller 401, an arbitration unit 402, a multiplexer 403, and a queue 404.

The queue controller 401 selectively controls the queue protocol of the arbiter 310 according to a queue output request signal received from the hub 320. That is, if it is determined by receiving the queue output request signal that the command bus is not in a busy state, the queue controller 401 sets the queue protocol of the arbiter 310 to the bypass mode and operates using the queue protocol. However, if it is determined by receiving the queue output request signal that the command bus is in the busy state, the queue controller 401 sets the queue protocol of the arbiter 310 to the active mode and operates using the queue protocol.

When the command stored in the queue 404 is output, the queue controller 401 outputs a queue input announcement signal to the hub 320. Accordingly, the hub 320 recognizes that the command is output from the arbiter 310, and the queue controller 401 determines whether the command is received based on communication data received from the arbitration unit 402.

If a master request signal (MASTER Req) is received from at least one of the first through nth masters 300_1 through 300_{—}n, the arbitration unit 402 performs a preset arbitration algorithm, determines a priority, outputs a master grant signal (MASTER Gnt) to the corresponding master according to the priority, and transmits information about the output master grant signal to the queue controller 401.

The multiplexer 403 transmits either a current received command or a command output from the queue 404 according to an operation mode of the queue protocol of the arbiter 310. That is, if the queue protocol of the arbiter 310 is set to the bypass mode, the multiplexer 403 is controlled by the queue controller 401 and selects and outputs the current received command. However, if the queue protocol of the arbiter 310 is set to a mode besides the bypass mode, the multiplexer 403 is controlled by the queue controller 401 and selects and outputs the command output from the queue 404. The mode besides the bypass mode can include the active mode. The multiplexer 403 can be defined as a command transmitter.

The queue 404 has a FIFO structure and stores a plurality of commands. If the queue protocol of the arbiter 310 is set to a mode besides the bypass mode by the queue controller 401, the queue 404 stores a current received command and outputs a command stored using the FIFO method. The output command is transmitted to the multiplexer 403.

The hub 320 analyzes slave queue full state information received from the first through mth slaves 330_1 through 330_{—}m and transmits information to the arbiter 310 by which whether the command bus is in the busy state can be determined. That is, if the slave queue full state information shows that a queue of a corresponding slave is in a full state, the hub 320 transmits information to the arbiter 310 by which it can be determined that the command bus of the corresponding slave is in the busy state. However, if the slave queue full state information shows that a queue of a corresponding slave is not in the full state, the hub 320 transmits information to the arbiter 310 by which it can be determined that the command bus of the corresponding slave is not in the busy state. The information by which it can be determined whether the command bus is in the busy state transmitted to the arbiter 310 is the queue output request signal.

If the queue input announcement signal is received from the arbiter 310, the hub 320 outputs a command enable signal to a corresponding slave and transmits the command received from the arbiter 310 to the first through mth slaves 330_1 through 330_{—}m.

Accordingly, only a slave that has received the command enable signal of the first through mth slaves 330_1 through 330_{—}m performs a receive operation on the command received from the hub 320.

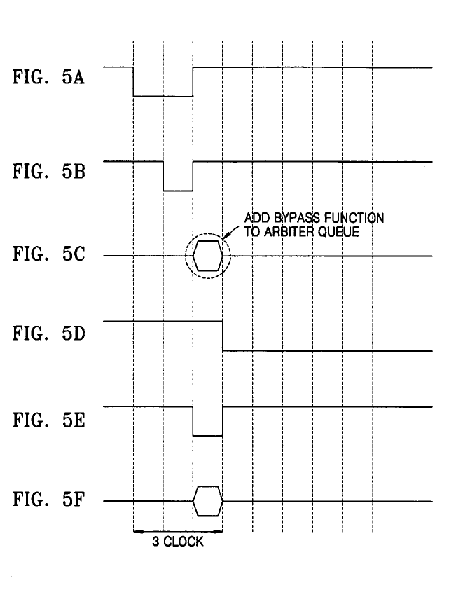

FIG. 5A through FIG. 5F are timing diagrams illustrating operation of the command bus of the pipeline bus system as illustrated in FIG. 3.

That is, if one of the first through nth masters 300_1 through 300_{—}n sends a request for a command transmission to the arbiter 310, the arbiter 310 performs the preset arbitration algorithm and determines a priority as shown in FIG. 5A. Since one master sends a request for the command transmission, the arbiter 310 transmits a signal granting access to the command bus to the master as shown in FIG. 5B.

Accordingly, a command is transmitted from the master to the arbiter 310 as shown in FIG. 5C. If the arbiter 310 determines from a received signal, as shown in FIG. 5D, that the command bus is not in a busy state, a command enable signal is transmitted to a corresponding slave, as shown in FIG. 5E, and the command transmitted from the master is transmitted to the corresponding slave as shown in FIG. 5F.

FIG. 5A through FIG. 5F illustrate a case where a queue of a target slave is not in a full state when a master transmits a command. In this case, if a pipeline bus system according to an embodiment of the present invention transmits a command, a period of 3 clock pulses is required for transmitting the command as illustrated in FIG. 5A through FIG. 5F.

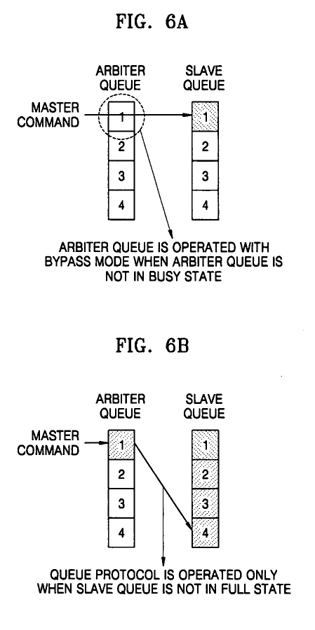

FIG. 6A illustrates an operation in a queue protocol according to an embodiment of the present invention when the command bus is not in a busy state. Referring to FIG. 6A, a queue of the pipeline bus system according to an aspect of the present invention is generated only in an arbiter and a slave. Also, the queue in the arbiter can bypass a command according to a situation.

FIG. 6B illustrates an operation in the queue protocol according to an embodiment of the present invention when the command bus is in the busy state. Referring to FIG. 6B, if the slave queue is in a full state, the command is stored in the arbiter queue, and when the slave queue is not in the full state, the command stored in the arbiter queue is transmitted to the slave.

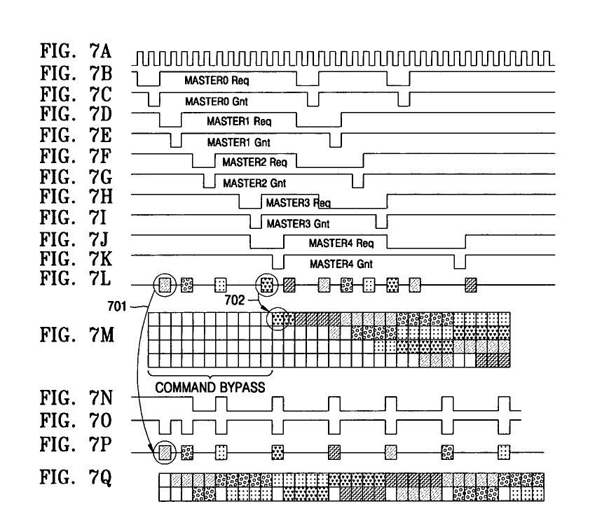

FIGS. 7A through 7Q are timing diagrams of modules of the pipeline bus system when a command is transmitted according to an embodiment of the present invention. FIGS. 7A through 7Q illustrate a case where 5 masters request a command transmission, the arbiter queue can store 4 commands, and the slave queue can store 2 commands.

FIG. 7A illustrates a clock signal, FIG. 7B illustrates a command transmission request signal of a first master MASTER0, FIG. 7C illustrates a command bus access grant signal for the first master MASTER0, FIG. 7D illustrates a command transmission request signal of a second master MASTER1, FIG. 7E illustrates the command bus access grant signal for the second master MASTER1, FIG. 7F illustrates a command transmission request signal of a third master MASTER2, FIG. 7G illustrates the command bus access grant signal for the third master MASTER2, FIG. 7H illustrates a command transmission request signal of a fourth master MASTER3, FIG. 71 illustrates the command bus access grant signal for the fourth master MASTER3, FIG. 7J illustrates a command transmission request signal of a fifth master MASTER4, and FIG. 7K illustrates the command bus access grant signal for the fifth master MASTER4.

FIG. 7L illustrates commands transmitted from the first through fifth masters, MASTER0˜MASTER4, FIG. 7M illustrates an example of a command storage structure of an arbiter queue, and FIG. 7N illustrates a signal representing a full state of a target slave queue. In FIG. 7N, a logic high indicates that the target slave queue is not in the full state and a logic low indicates that the target slave queue is in the full state.

FIG. 7O illustrates a command enable signal transmitted from a hub to the target slave, FIG. 7P illustrates the commands being input to the target slave, and FIG. 7Q illustrates an example of a command storage structure of the target slave queue.

As shown in FIG. 7M, if determined that the command bus is not in the busy state based on the state of the target slave queue and the command transmission request timings of the masters, the arbiter queue is set to the bypass mode, does not store the commands received from the masters, and bypasses the commands.

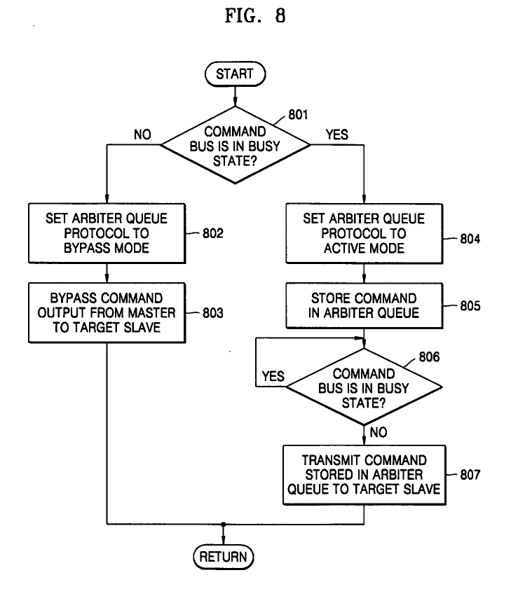

FIG. 8 is a flowchart illustrating a command transmission method according to an embodiment of the present invention.

In operation 801, it is determined whether a command bus of a pipeline bus system is in a busy state. The command bus can be set with reference to a target slave. Therefore, whether the command bus is in the busy state can be determined referring to a state of the target slave queue. For example, if the target slave queue is in a full state, it can be determined that command bus is in the busy state. On the other hand, if the target slave queue is not in the full state, it can be determined that the command bus is not in the busy state.

If determined that the command bus is not in the busy state in operation 801, an arbiter queue protocol is set to the bypass mode in operation 802, a command transmitted from a master is bypassed to the target slave in operation 803, and the process returns to operation 801.

If determined that the command bus is in the busy state in operation 801, the arbiter queue protocol is set to the active mode in operation 804, and the command transmitted from the master is stored in an arbiter queue in operation 805.

If determined that the command bus is in the busy state in operation 806, a state of the command stored in the arbiter queue is maintained. However, if determined that the command bus is not in the busy state in operation 806, the command stored in the arbiter queue is transmitted to the target slave using a FIFO method in operation 807, and the process returns to operation 801.

As described above, according to an aspect of the present invention, since a hub queue is removed and a queue protocol using an arbiter queue and a slave queue is used in a pipeline bus system, occurrence of latency is decreased when a command is transmitted.

Also, when a command bus is not in a busy state, since an arbiter queue protocol is used so that the command is bypassed in an arbiter, a master can communicate with a target slave in a 1:1 state.

Furthermore, since the arbiter queue protocol is used only when required, occurrence of latency according to command transmission decreases and transmission efficiency of the command bus is improved. In particular, when a plurality of masters transmit commands to a single target slave, since the arbiter queue protocol is used only when the slave queue is in a full state, the occurrence of latency according to the command transmission is further decreased.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A command transmission method in a pipeline bus system to which at least one master and at least one slave are connected, the method comprising:
determining whether a command bus of the pipeline bus system is in a busy state; and
transmitting a command from the at least one master to a target slave while selectively using a queue protocol of an arbiter of the pipeline bus system according to a result of the determination.

2. The method of claim 1, wherein whether the command bus is in the busy state is determined by a queue state of the target slave.

3. The method of claim 1, wherein, during the transmission of the command, if the command bus is not in the busy state, the queue protocol of the arbiter is set to a bypass mode and the command is bypassed to the target slave, and
if the command bus is in the busy state, the queue protocol of the arbiter is set to an active mode, the command is stored in a queue of the arbiter, and the command stored in the queue of the arbiter is transmitted to the target slave.

4. The method of claim 3, wherein, after the queue protocol of the arbiter is set to the active mode, if determined that the command bus is not in the busy state, the command stored in the queue of the arbiter is transmitted to the target slave.

5. A command transmission apparatus of a pipeline bus system to which at least one master is connected, the apparatus comprising:
a target slave, which is connected to the pipeline bus system and transmits state information for determining whether a command bus of the pipeline bus system is in a busy state; and
an arbiter, which transmits a command from the at least one master to the target slave while a queue protocol is selectively used according to the state information.

6. The apparatus of claim 5, wherein the state information includes information regarding a queue state of the target slave.

7. The apparatus of claim 5, wherein, if the command bus is not in the busy state, the arbiter sets the queue protocol to a bypass mode and bypasses the command to the target slave, and if the command bus is in the busy state, the arbiter sets the queue protocol to an active mode, stores the command in a queue of the arbiter, and transmits the stored command to the target slave.

8. The apparatus of claim 5, wherein the arbiter comprises:
a queue controller, which sets and controls a mode of the queue protocol according to whether the command bus is in the busy state;
a queue, which, if the queue protocol is set to a mode besides a bypass mode, is controlled by the queue controller and stores the command received from the at least one master; and
a command transmitter, which, if the queue protocol is set to the bypass mode, transmits the command received from the at least one master to the target slave, and if the queue protocol is set to the mode besides the bypass mode, transmits a command output from the queue to the target slave.

9. The apparatus of claim 5, further comprising:
a hub, which determines whether the command bus is in the busy state based on the state information, transmits a result of the determination to the arbiter, and transmits the command received from the arbiter to the target slave.

10. A command transmission apparatus of a pipeline bus system comprising:
at least one master transmitting a command to an arbiter;
the arbiter determining a state of a command bus; and
a target slave receiving the command depending on the determination made by the arbiter using a queue protocol of the arbiter.

11. The apparatus of claim 10, wherein the arbiter includes a queue controller, an arbitration unit, a multiplexer and a queue.

12. The apparatus of claim 11, wherein the queue controller controls the queue protocol of the arbiter.

13. The apparatus of claim 11, wherein if determined that the command bus is not in a busy state, the queue controller sets the queue protocol of the arbiter to a bypass mode and operates using the queue protocol.

14. The apparatus of claim 11, wherein if determined that the command bus is in a busy state, the queue controller sets the queue protocol of the arbiter to an active mode and operates using the queue protocol.

15. The apparatus of claim 10, wherein if a plurality of masters request a command transmission, the arbiter determines priority and grants access of the command bus.

16. The apparatus of claim 10, wherein if a single master requests a command transmission, the arbiter grants the master access to the command bus.

17. A command transmission method in a pipeline bus system having a master, an arbiter and a slave, the method comprising:
transmitting a command from the master to the arbiter;
determining a state of a command bus at the arbiter using state information received from the slave; and
transmitting the command to the slave depending on the determination made by the arbiter using the state information received from the slave and a queue protocol.

18. The method of claim 17, wherein if determined that the command bus is not in a busy state, setting the queue protocol of the arbiter to a bypass mode.

19. The method of claim 17, wherein if determined that the command bus is in a busy state, setting the queue protocol of the arbiter to an active mode.

20. The method of claim 17, wherein if more than one master requests a command transmission, the arbiter determines priority of the request and grants access of the command bus to a chosen master.

21. The method of claim 10, wherein if a single master requests a command transmission, the arbiter grants the single master access to the command bus.
